(19) United States
(12) Patent Application Publication
(10) Pub. No.: US 2009/0327886 A1
(43) Pub. Date: Dec. 31, 2009

(54) USE OF SECONDARY FACTORS TO ANALYZE USER INTENTION IN GUI ELEMENT ACTIVATION

(75) Inventors: Chris Whytock, Seattle, WA (US); Peter Vale, Redmond, WA (US); Steven Seow, Maple Valley, WA (US); Carlos Pessoa, Redmond, WA (US); Paul Armistead Hoover, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/253,726

(22) Filed: Oct. 17, 2008

Related U.S. Application Data
(60) Provisional application No. 61/076,526, filed on Jun. 27, 2008.

(51) Int. Cl. G06F 3/01

(52) U.S. Cl. 715/702

(57) ABSTRACT

An interactive media display system and a method of activating a graphical user interface element presented by the interactive media display system are provided. The method includes presenting the graphical user interface element via a touch-sensitive display surface of the interactive media display system; receiving a user input at the touch-sensitive display surface; determining whether one or more secondary factors associated with the user input indicate an intentional contact with the graphical user interface element that is presented via the touch sensitive display surface; activating the graphical user interface element if the one or more secondary factors indicate the intentional contact with the graphical user interface element; and disregarding the user input by not activating the graphical user interface if the one or more secondary factors do not indicate the intentional contact.

### CROSS-REFERENCE TO RELATED APPLICATIONS

This application claims priority to U.S. Provisional Patent Application No. 61/076,526, entitled “USE OF SECONDARY FACTORS TO ANALYZE USER INTENTION IN GUI ELEMENT ACTIVATION,” filed Jun. 27, 2008, naming Chris Whytock, Peter Vale, Steven Seow, and Carlos Pessoa as inventors, the disclosure of which is hereby incorporated by reference in its entirety and for all purposes.

### BACKGROUND

A computing device may include a graphical display that presents graphical user interfaces which enable users to interact with the computing devices in various ways. Some graphical user interfaces may include graphical elements representing buttons or icons that provide user access to software applications or other services of the computing device. Furthermore, some graphical displays may include touch-sensitive functionality that enables users to physically touch the graphical displays to select, manipulate, or otherwise interact with these graphical elements.

### SUMMARY

An interactive media display system and a method of activating a graphical user interface (GUI) element are provided. In one embodiment, a user intention is identified with respect to activation of graphical user interface elements displayed via a touch-sensitive display surface. The user input may be received at the touch-sensitive display surface where one or more secondary factors associated with the user input may be analyzed to determine whether the user input represents an intentional contact with the graphical user interface element. The graphical user interface element may be activated if the one or more secondary factors indicate the intentional contact with the graphical user interface element. Alternatively, the user input may be disregarded by not activating the graphical user interface if the one or more secondary factors do not indicate the intentional contact.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of an interactive media display system.

FIG. 2 shows a schematic depiction of example instructions that may be held in memory and executed by a logic subsystem of the interactive media display system of FIG. 1.

FIGS. 3 and 4 show example user interactions with the interactive media display system of FIG. 1.

FIG. 5 shows a first example embodiment of a method for determining if a graphical user interface element has been intentionally touched.

FIG. 6 shows a second example embodiment of a method for determining if a graphical user interface element has been intentionally touched.

FIG. 7 shows an example embodiment of a method of activating a graphical user interface element presented by an interactive media display system.

FIG. 8 shows an example interaction between a user and a graphical user interface element.

FIG. 9 shows a schematic depiction of a non-limiting example of the interactive media display system of FIG. 1.

### DETAILED DESCRIPTION

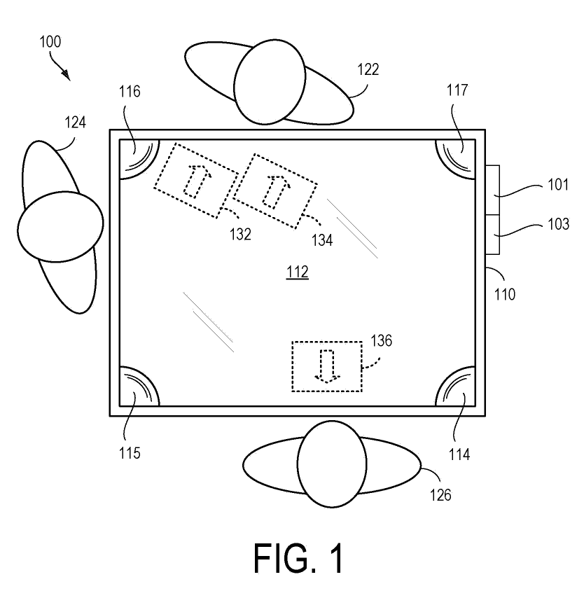

FIG. 1 is a schematic depiction of an interactive media display system 100. The example interactive media display system 100 includes a touch-sensitive display surface 110. Touch-sensitive display surface 110 includes a touch-sensitive region 112. One or more user inputs may be received from one or more users at the touch-sensitive display surface via touch-sensitive region 112. Interactive media display system 100 may additionally or alternatively receive user inputs by other suitable user input devices (e.g., keyboard, mouse, microphone, etc.).

Touch-sensitive display surface 110 may be configured to present one or more graphical user interface elements. As a non-limiting example, interactive media display system 100 may include one or more graphical user interface (GUI) buttons (e.g., 114, 115, 116, 117) located at or disposed along a perimeter of touch-sensitive display surface 110 for receiving a user input. For example, a GUI button may be located at each corner of the touch sensitive display surface. The interactive media display system 100 may include still other suitable graphical user input elements, including, but not limited to, menus, GUI sliders, GUI dials, GUI keyboards, GUI icons, GUI windows, etc. While GUI buttons have been presented by example, it should be understood that the teachings of this disclosure are applicable to virtually any GUI element.

Interactive media display system 100 can execute various instructions, including system instructions and application instructions. As one non-limiting example, the interactive media display system 100 may execute instructions that cause the touch-sensitive display surface to present graphical information, including one or more GUI elements (e.g., 132, 134, and 136), which can also serve as GUI elements capable of receiving user input.

Each of users 122, 124, and 126 can interact with the depicted GUI elements. As one non-limiting example, by touching the touch-sensitive region of the touch-sensitive display surface upon which the GUI element are presented (e.g., displayed), a user may interact with or gain access to an application to which that GUI element belongs. For example, user 126 can interact with GUI element 136 by touching the touch-sensitive region on or near GUI element 136, which may in turn provide the user with access to a particular application. As another example, user 126 may interact with GUI button 114 by touching the touch-sensitive region on or near GUI button 114.

Interactive media display system 100 may include a logic subsystem 101 and memory 103, as schematically shown in FIG. 1. Logic subsystem 101 may be configured to execute one or more instructions for implementing the herein described methods. For example, the logic subsystem may be configured to execute one or more instructions that are part of one or more programs, routines, objects, components, data structures, or other logical constructs. Such instructions may be implemented to perform a task, implement an abstract data type, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory 103 may be a device configured to hold instructions that, when executed by the logic subsystem, cause the logic subsystem to implement the herein described methods and processes. Memory 103 may include volatile portions and/or nonvolatile portions. In some embodiments, memory 103 may include two or more different devices that may cooperate with one another to hold instructions for execution by the logic subsystem. In some embodiments, logic subsystem 101 and memory 103 may be integrated into one or more common devices and/or computing systems.

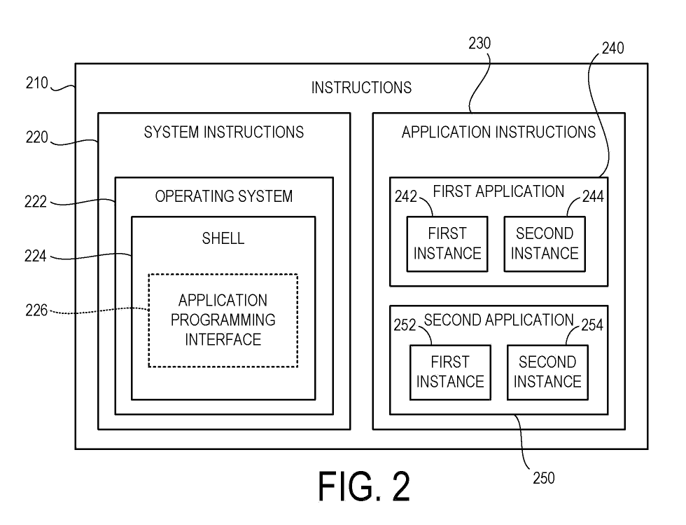

FIG. 2 is a schematic depiction of at least some of the instructions that may be held in memory 103 and executed by logic subsystem 101 of the interactive media display system. As shown in FIG. 2, these instructions, as indicated at 210, can include system instructions 220 and application instructions 230.

System instructions can refer to any suitable instruction that may be executed by the interactive media display system to manage and control the interactive media display system so that the application instructions can perform a task. As one non-limiting example, system instructions can define an operating system 222 of the interactive media display system and may further define a shell 224. As will be described herein, shell 224 can serve as a central source of information associated with each GUI element that is displayed.

Application instructions 230 can define one or more applications. For example, a first application 240 and a second application 250 are depicted schematically. Further, the application instructions can define one or more instances of each application. For example, first application 240 can include a first instance 242 and a second instance 244. Further still, each of these instances can define one or more respective GUI elements that may be displayed by the touch sensitive display surface. Thus, a user may interact with a particular application or instance of an application via the GUI element(s) of that application.

Applications can interact with the operating system to employ the capabilities of the interactive media display system to a task that the users wish to perform. For example, each of the applications can communicate with the shell to facilitate the display of various GUIs elements presented by the touch-sensitive display surface. The operating system itself may also display various GUI elements. As one non-limiting example, the system instructions can utilize an application programming interface (API), or shell-side aspects of an API, as indicated at 226.

Among other abilities, the API may allow the shell and the applications to communicate user input information to one another. As described herein, an API may refer to any suitably defined communicative interface between two or more aspects of the interactive media display system (e.g., between the shell and an application). An API may be implemented in any manner suitable for defining the communicative interface.

As a non-limiting example, one or more secondary factors associated with user input may be communicated to the applications by the shell via the application programming interface, whereby the applications may utilize the one or more secondary factors to determine whether the user intended to contact and thereby activate a particular graphical user interface element of the application.

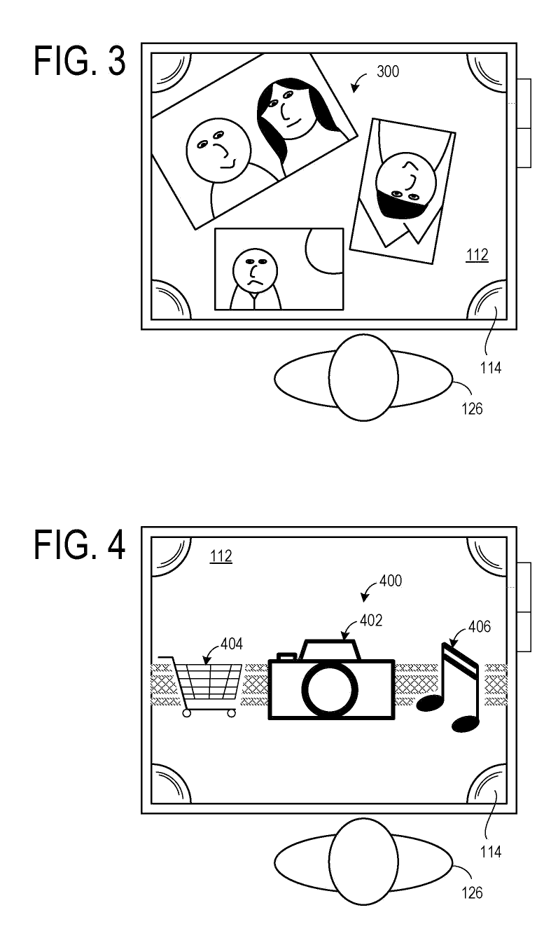

FIG. 3 schematically shows user 126 using interactive media display system 100 to run or interact with a photo viewing application 300. Photo viewing application 300 is provided as a non-limiting example of many different applications that may be available to a user. When running photo viewing application 300, or another suitable application, the operating system displays GUI buttons, such as GUI button 114, in the corners of touch-sensitive region 112. The GUI buttons may serve as a GUI element that a user can activate to exit a running application (e.g., photo viewing application 300), and view an application launcher 400, as shown in FIG. 4.

Application launcher 400 can be configured to assist the user in selecting an application to run next. For example, application launcher 400 includes a camera icon 402. When interactive media display system has determined that camera icon 402 has been intentionally touched or contacted, the operating system may activate the photo viewing application. Application launcher 400 also includes a shopping cart icon 404 for activating a shopping application and a note icon 406 for activating a music application. When a user is operating one or more of the above mentioned applications, or another suitable application, the user can activate GUI button 114 to return to application launcher 400 to select a different application.

Many GUI elements can have a significant impact on the action that the interactive media display system takes responsive to selection of those elements. An example of such a GUI element is GUI button 114. In one example, pressing the GUI button may cause a drastic change in the user experience, as application launcher 400 may be summoned, and the previously running application may be hidden. This change can provide a good or desirable user experience if the change is intended by the user that has intentionally pressed GUI button 114. However, this change can provide an unexpected user experience if the user does not intend to press GUI button 114 and the application launcher 400 appears unexpectedly. Similarly, a virtually limitless number of other accidental or unintentional user actions may result in unintended consequences that may provide an unexpected user experience. As non-limiting examples, a user may accidentally close a window, quit an application, put a system to sleep, cause a text box to hover, shut-down the interactive media display system, etc.

In order to reduce the likelihood of providing an unexpected user experience, heuristics and/or other logic can be employed to determine if GUI button 114 is intentionally pressed. In some embodiments, the logic may be employed by one or more of the operating system and the applications through communication with the operating system via an API.

For example, the logic may consider, in addition to the press and release of GUI button 114, one or more potential secondary pieces of information or secondary factors of the user input that can serve as an indication of user intention. It is worth noting again that while described in the context of GUI button 114, such logic can additionally or alternatively be applied to other GUI elements. In general, this approach can be used in any situation in order to control user experience at least in part by considering the intentions of a user. As a non-limiting example, unintentional user actions that may provide an otherwise unexpected user experience can be identified by the interactive media display system and the consequences of such actions can be modified accordingly.

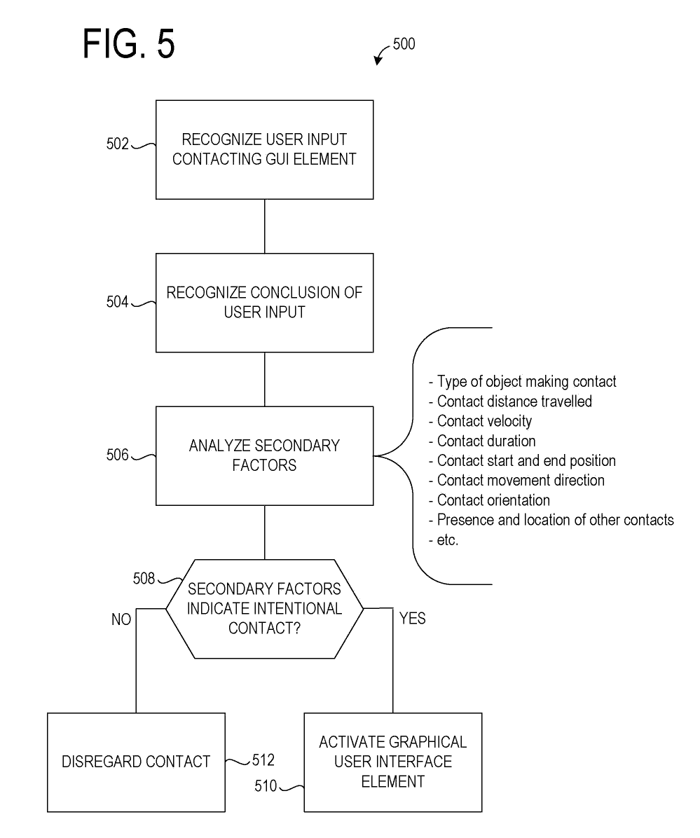

FIG. 5 shows a process flow of an example method 500 for determining if a GUI element is intentionally touched (or otherwise selected or activated). At 502, method 500 includes recognizing a user input contacting a GUI element. In the case of a touch-activated computing device, such contacting may include a finger, stylus, or other object physically touching the GUI element (i.e., the portion of the screen displaying the GUI element). In the case of a pointer-based GUI, such contacting may include a pointer, which may be controlled by a mouse, trackball, joystick, or other device, being moved over the GUI element.

At 504, method 500 includes recognizing a conclusion of the user input (e.g., finger lifted from touch surface, stylus lifted from touch surface, pointer exiting GUI element, etc.).

At 506, method 500 includes analyzing one or more secondary factors. Such secondary factors may include, but are not limited to, the type of object making contact, the distance travelled by the contact, the contact velocity, the contact duration, the contact start and end positions, the contact movement direction, the contact orientation, and/or the presence and location of other contacts. At 508, it is determined if the secondary factors indicate an intentional contact. If the secondary factors indicate an intentional contact, at 510, the GUI element may be activated. If the secondary factors indicate an accidental touch, at 512, the contact can be disregarded and the GUI element will not be activated.

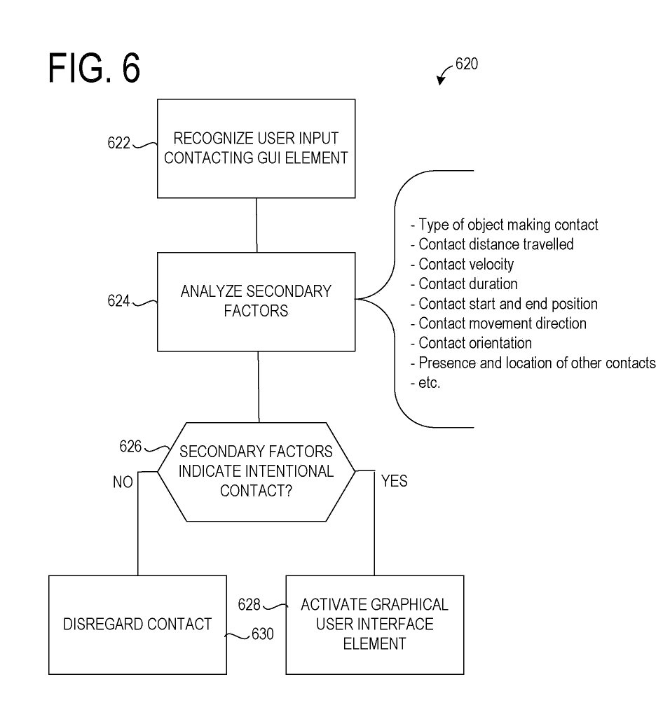

FIG. 6 shows a process flow of another example method 620 for determining if a GUI element is intentionally touched (or otherwise selected or activated). Method 620 is similar to method 510, but the secondary factors are analyzed before the conclusion of the user input. For example, user input contacting the graphical user interface element may be recognized at 622. Secondary factors may be analyzed at 624 before conclusion of the user input contacting the graphical user interface element. At 626, it may be judged whether the secondary factors indicate an intentional contact with the graphical user interface element. At 628, the graphical user interface element may be activated if the secondary factors indicate that the contact was intentional. Alternatively, at 630, the contact may be disregarded if the secondary factors do not indicate that the contact was intentional.

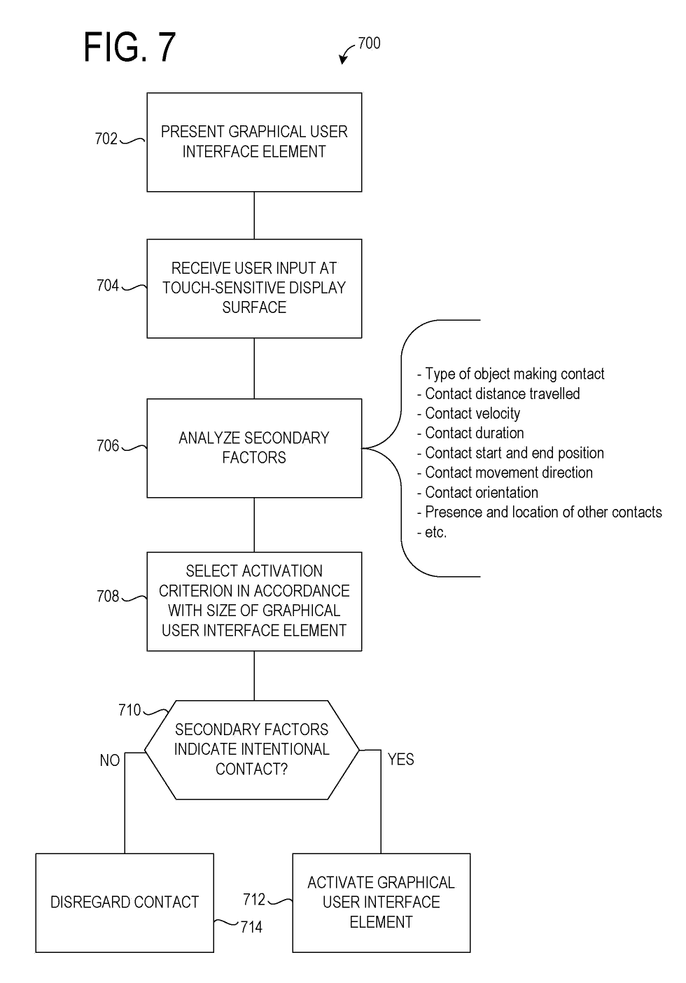

In some embodiments, one or more of the secondary factors may be considered on a pass/fail basis in which the GUI element will only be activated if a condition for that secondary factor passes. As a non-limiting example, a pass condition for contact duration may be greater than or equal to 50 milliseconds and less than or equal to 1000 milliseconds. As another example, a pass condition for contact velocity may be less than or equal to 0.17 pixels per millisecond. As another non-limiting example, a pass condition for the type of object making the contact may be the object is recognized as a finger. In other words, if a tag or another unidentified object makes the contact, the condition fails. In some embodiments, if a condition for any one of the secondary factors fails, the contact will be disregarded. In other embodiments, the contact will result in activation of the GUI element unless a fail condition exists for all of the secondary factors. The above example values may be utilized as threshold values in method 700 of FIG. 7.

In some embodiments, neural network logic may be used to analyze the secondary factors and determine if contact is intentional. In some embodiments, fuzzy logic may be used to analyze the secondary factors and determine if a contact is intentional. For example, each secondary factor that is considered can be given a static or dynamic weighting relative to other secondary factors. The pass/fail status of a condition associated with each considered secondary factor can then be used to calculate an overall likelihood of intention based on the relative weighting.

In some embodiments, one or more secondary factors may be considered with increased granularity. In other words, such a secondary factor may have three or more different conditions, and each condition can indicate intentional or accidental contacting to a different degree. For example, a contact duration between 50 and 1000 milliseconds may suggest an 85% likelihood of intentional contacting; a contact duration less than 50 milliseconds may suggest a 40% likelihood of intentional contacting; and a contact duration greater than 1000 milliseconds may suggest a 5% likelihood of intentional contacting. The various likelihoods from the different secondary factors under consideration can be collectively analyzed to assess an overall likelihood that the contact was intentional or accidental. In such a fuzzy logic analysis, the various secondary factors can be weighted equally or differently.

As mentioned above, a variety of different secondary factors may serve as an indication of intentional contacting or accidental contacting. The following are non-limiting examples of such secondary factors.

The type of object may be analyzed to determine if an expected object is used to make the contact. In the case of a surface computing device, it may be expected that a user's finger will be used to activate certain GUI elements. Therefore, if another object is recognized contacting those GUI elements, it may be more likely that the contact is accidental or that it is not meant to activate the GUI element. Similarly, it may be expected that another type of object will be used to activate other GUI elements, and intention-determinations can be made accordingly.

A contact distance travelled within a GUI element after the GUI element is initially contacted and before the user input exits the GUI element can serve as an indication of intention. A short contact distance may indicate an intentional contact, while a longer contact distance may indicate an accidental brush across the GUI element.

A contact velocity of user input within a GUI element can serve as an indication of intention. A zero or low contact velocity may indicate an intentional contact, while a faster contact velocity may indicate and accidental brush across the GUI element.

A contact duration can serve as an indication of intention. Too short of a contact duration may indicate an accidental brush or a user quickly changing her mind. Too long of a contact duration may indicate a user not paying attention to that GUI element. A contact duration falling between these scenarios may indicate an intentional contact. In some embodiments, a GUI element may change appearances after an initial duration has passed (e.g., 50 milliseconds), so as to provide the user with visual feedback that the GUI element recognizes the users input.

The start and end position of a contact of a GUI element can serve as an indication of intention. A start and/or end position in a middle region of the GUI element may indicate an intentional contact. On the other hand, a start near a perimeter of the GUI element and an end near the perimeter of the GUI element may indicate an accidental contact. The same can be true for contact movement direction.

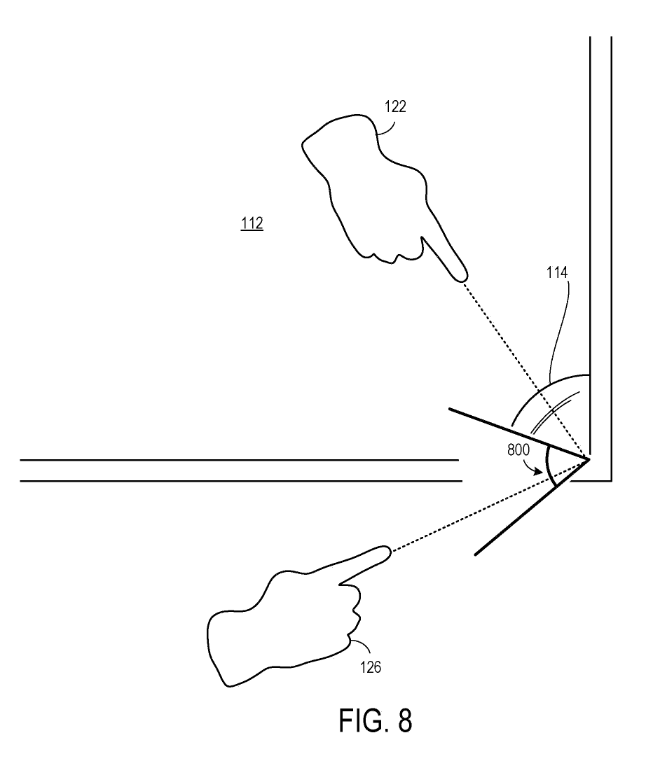

Contact orientation (e.g., the direction a user's finger is pointed) can serve as an indication of intention. A user that is contacting a GUI element within a predetermined range of angles (e.g., ±30°) from an anticipated contact direction may indicate an intentional contact. For example, FIG. 8 indicates a ±30° range 800 in which an orientation of a contact will be considered to indicate an intentional contact. FIG. 8 shows user 126 reaching to contact GUI button 114 from within range 800. As such, the orientation of the contact of user 126 will be analyzed as indicating an intentional contact. On the other hand, user 122 is reaching to contact GUI button 114 from across the interactive media display system and outside of range 800. As such, the orientation of the contact of user 122 will be analyzed as indicating an accidental contact. It should be understood that the size of the ranges and the anticipated contact direction can be selected individually for each different GUI element.

Furthermore, secondary factors that can be used to assess user intentions may include factors that are not directly related to user input. Virtually anything can be used as a secondary factor. Non-limiting examples of such factors include proximity of other contacts on the touch screen (and the types of those contacts), a user's previous tendencies, the time of day, etc.

The herein described intention-determination methods may help limit the frequency with which activation of graphical user interfaces cause unexpected results (e.g., opening an application launcher, closing a window, displaying hover text, etc.). Such intention-determination methods do not rely on a user to adjust behavior in order to get desired results. For example, a user need not click a user interface element three or more times, press a user interface element extra hard, touch a GUI element for an unnaturally long period of time, etc. To the contrary, the intention-determination method is designed to interpret the actions of a user, and determine which actions are intentional and which are accidental. As such, a user need not be trained or reprogrammed to act in an unnatural manner. Therefore, the intention-determination methods are well suited for environments in which a user is not specifically trained to interact with a GUI in a particular way.

It should be understood that a software developer's kit (SDK) or other application/system development framework may be configured to implement an API allowing developers to easily incorporate the herein described functionality in a variety of different GUI elements. As such, an application developer can easily add GUI elements and know when contact of such elements is intentional or accidental. Further, the SDK may expose the ability for an application to either modify or have the chance to pre or post process the secondary factors involved in making the disregard decision, or to override the heuristic's determination.

In light of the above teachings, FIG. 7 shows an example embodiment of a method 700 of activating a graphical user interface element. It should be appreciated that method 700 may be performed by interactive media display system 100 and may be used in combination with or as an alternative to methods 500 and 620.

At 702, the method may include presenting the graphical user interface element via a touch-sensitive display surface. At 704, the method may include receiving a user input at the touch-sensitive display surface. In some embodiments, receiving the user input at the touch-sensitive display surface includes recognizing an object contacting the touch-sensitive display surface. This object may include a user's hand or finger, a stylus, or some other object.

The user input received at 704 may be used by the interactive media display system to identify an initial location where the touch-sensitive display surface is initially contacted by the object and identify a final location where the object discontinues contact with the touch-sensitive display surface. As previously described with reference to method 620, the interactive media display system may analyze one or more secondary factors before the object discontinues contact with the touch-sensitive display surface.

At 706, the one or more secondary factors may be analyzed as previously described with reference to one or more of steps 506 or 624. As previously described, the one or more secondary factors may include: a contact duration of the user input at the touch-sensitive display surface; a characteristic (e.g. shape) of the object through which the user input contacts the touch-sensitive display surface; a contact distance travelled by the object across the touch-sensitive display surface; a contact velocity travelled by the object across the touch-sensitive display surface; a contact movement direction travelled by the user input across the touch-sensitive display surface; and a contact orientation at which the object contacts the touch-sensitive display surface, among others.

At 708, the method may optionally include selecting an activation criterion in accordance with a size of the graphical user interface element that is presented via the touch-sensitive display surface. In some embodiments, the activation criterion may include one or more thresholds that must be satisfied by the one or more secondary factors before the graphical user interface element is activated.

As a non-limiting example, the graphical user element may be activated only if some or all of the following are satisfied: a contact distance between the initial location and the final location exhibits a pre-determined relationship to a threshold contact distance; a contact duration between a time when the object initially contacts the touch-sensitive display surface at the initial location and a time when the object discontinues contact at the final location exhibits a pre-determined relationship to a threshold contact duration; and a contact velocity of the object between the initial location and the final location exhibits a predetermined relationship to a threshold contact velocity.

Further, in some embodiments, the interactive media display system may identify a proximity of the object to the graphical user interface element that is presented via the touch-sensitive display surface. The graphical user interface element may be activated only if the proximity of the object to the graphical user interface element exhibits a pre-determined relationship to a threshold proximity.

As yet another example, the interactive media display system may be configured to activate the graphical user interface element only if the initial location is at a location where the graphical user interface element is presented via the touch-sensitive display surface or if the final location is at the location where the graphical user interface element is presented via the touch-sensitive display surface.

In some embodiments, the activation criterion may be selected by adjusting one or more thresholds associated with the one or more secondary factors. For example, the method at 708 may include adjusting one or more of the threshold contact distance, the threshold contact duration, and the threshold contact velocity based on a size of the graphical user interface element (e.g., number of pixels, area, etc.) that is presented via the touch-sensitive display surface.

In some embodiments, the method at 708 may include selecting a magnitude of a threshold value for at least one of the secondary factors based on a threshold value of another secondary factor. For example, the interactive media display system may be configured to select at least one of the threshold contact distance, the threshold contact duration, and the threshold contact velocity based on a magnitude of another of the threshold contact distance, the threshold contact duration, and the threshold contact velocity.

At 710, the method may include determining whether one or more secondary factors associated with the user input indicate an intentional contact with the graphical user interface element that is presented via the touch sensitive display surface. In some embodiments, determining whether one or more secondary factors indicate the intentional contact includes comparing the one or more of the secondary factors to the activation criterion selected at 708. For example, if the above pre-determined relationship is exhibited between one or more of the secondary factors and their respective threshold values, then the one or more secondary factors may be determined to indicate an intentional contact with the graphical user interface element.

In some embodiments, the operating system (e.g., shell) of the interactive media display system may be configured to determine whether the user input indicates an intentional contact with the graphical user interface element. In other embodiments, the applications may be configured to receive the one or more secondary factors from the operating system via the API and determine whether the one or more secondary factors indicate an intentional contact with the graphical user interface element of the application. In this way, each application may utilize different secondary factors and/or different activation criterion for determining whether to activate a particular graphical user interface element.

At 712, the method may include activating the graphical user interface element if the one or more secondary factors indicate the intentional contact with the graphical user interface element. Activating the graphical user interface element may include one or more of highlighting the graphical user interface element, increasing a size of the graphical user interface element, and providing access to applications, services, or content associated with the graphical user interface element.

In some embodiments, the graphical user interface element may be activated if the activation criterion is satisfied by the one or more secondary factors associated with the user input. Where the applications determine that an intentional contact is indicated by the secondary factors of the user input, the applications may provide a response to the operating system via the API to cause the appropriate graphical user interface element to be activated. In some embodiments, the operating system and the applications may each use one or more secondary factors to independently determine whether the user input indicates an intentional contact with or activation of the graphical user element, whereby one of the operating system and the application may be configured to override the decision of the other.

At 714, the method may include disregarding the user input by not activating the graphical user interface if the one or more secondary factors do not indicate the intentional contact. In some embodiments, the user input is disregarded if the activation criterion is not satisfied by the one or more secondary factors associated with the user input. Where the applications determine that an intentional contact is not indicated by the secondary factors of the user input, the applications may provide a response to the operating system via the API to cause the appropriate graphical user interface element to remain deactivated, thereby disregarding the user input.

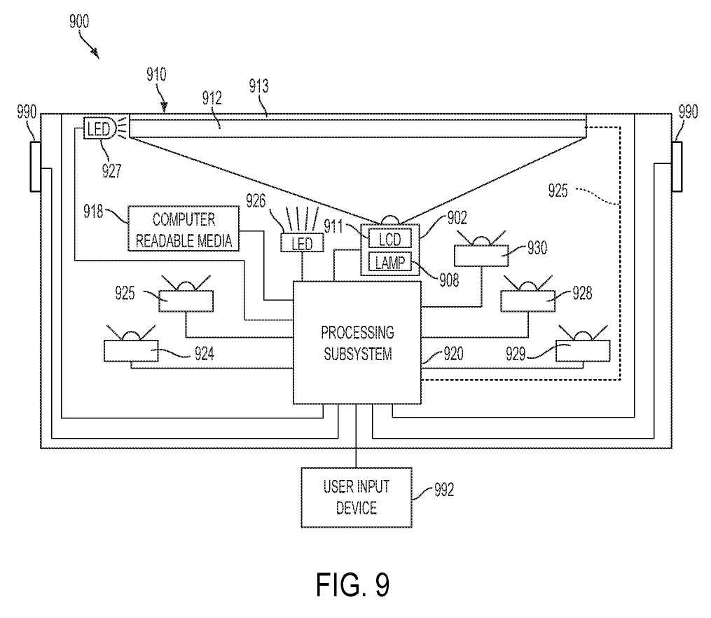

FIG. 9 shows a schematic depiction of a non-limiting example of an interactive media display system 900 capable of executing the process flows described herein. It should be understood that devices other than those depicted by FIG. 9 can be used to carry out the various approaches described herein without departing from the scope of the present disclosure.

Interactive media display system 900 includes a projection display system having an image source 902 that can project images onto display surface 910. Image source 902 can include an optical or light source 908, such as the depicted lamp, an LED array, or other suitable light source. Image source 902 may also include an image-producing element 911, such as the depicted LCD (liquid crystal display), an LCOS (liquid crystal on silicon) display, a DLP (digital light processing) display, or any other suitable image-producing element. Display surface 910 may include a clear, transparent portion 912, such as a sheet of glass, and a diffuser screen layer 913 disposed on top of the clear, transparent portion 912. In some embodiments, an additional transparent layer (not shown) may be disposed over diffuser screen layer 913 to provide a smooth look and feel to the display surface. In this way, transparent portion 912 and diffuser screen layer 913 can form a non-limiting example of a touch-sensitive region of display surface 910 as previously described with reference to 112.

Continuing with FIG. 9, interactive media display system 900 may further include a processing subsystem 920 (e.g., logic subsystem 101) and computer-readable media 918 (e.g., memory 103) operatively coupled to the processing subsystem 920. Computer-readable media 918 may include removable computer readable media and non-removable computer readable media. For example, computer readable media 918 may include one or more CDs, DVDs, and flash memory devices, among other suitable computer readable media devices. Processing subsystem 920 may be operatively coupled to display surface 910. As previously described with reference to FIG. 1, display surface 910, in at least some examples, may be configured as a touch-sensitive display surface. Processing subsystem 920 may include one or more processors for executing instructions that are stored at the computer-readable media. The computer-readable media may include the previously described system instructions and/or application instructions. The computer-readable media may be local or remote to the interactive media display system, and may include volatile or non-volatile memory of any suitable type. Further, the computer-readable media may be fixed or removable relative to the interactive media display system.

The instructions described herein can be stored or temporarily held on computer-readable media 918, and can be executed by processing subsystem 920. In this way, the various instructions described herein, including the system and application instructions, can be executed by the processing subsystem, thereby causing the processing subsystem to perform one or more of the operations previously described with reference to the process flow. It should be appreciated that in other examples, the processing subsystem and computer-readable media may be remotely located from the interactive media display system. As one example, the computer-readable media and/or processing subsystem can communicate with the interactive media display system via a local area network, a wide area network, or other suitable communicative coupling, via wired or wireless communication.

To sense objects that are contacting or near to display surface 910, interactive media display system 900 may include one or more image capture devices 924, 925, 928, 929, and 930 configured to capture an image of the backside of display surface 910, and to provide the image to processing subsystem 920. The diffuser screen layer 913 can serve to reduce or avoid the imaging of objects that are not in contact with or positioned within a few millimeters or other suitable distance of display surface 910, and therefore helps to ensure that at least objects that are touching transparent portion 912 of display surface 910 are detected by image capture devices 924, 925, 928, 929, and 930.

These image capture devices may include any suitable image sensing mechanism. Examples of suitable image sensing mechanisms include but are not limited to CCD and CMOS image sensors. Further, the image sensing mechanisms may capture images of display surface 910 at a sufficient frequency to detect motion of an object across display surface 910. Display surface 910 may alternatively or further include an optional capacitive, resistive or other electromagnetic touch-sensing mechanism, as illustrated by dashed-line connection 921 of display surface 910 with processing subsystem 920.

The image capture devices may be configured to detect reflected or emitted energy of any suitable wavelength, including but not limited to infrared and visible wavelengths. To assist in detecting objects placed on display surface 910, the image capture devices may further include an additional optical source or emitter such as one or more light emitting diodes (LEDs) 926 and/or 927 configured to produce infrared or visible light. Light from LEDs 926 and/or 927 may be reflected by objects contacting or near display surface 910 and then detected by the image capture devices. The use of infrared LEDs as opposed to visible LEDs may help to avoid washing out the appearance of projected images on display surface 910.

In some examples, one or more of LEDs 926 and/or 927 may be positioned at any suitable location within interactive media display system 900. In the example of FIG. 9, a plurality of LEDs may be placed along a side of display surface 910 as indicated at 927. In this location, light from the LEDs can travel through display surface 910 via internal reflection, while some light can escape from display surface 910 for reflection by an object on the display surface 910. In other examples, one or more LEDs indicated at 926 may be placed beneath display surface 910 so as to pass emitted light through display surface 910.

As described herein, the interactive media display system can receive various user inputs from one or more users via user input devices other than the touch-sensitive display surface. For example, as indicated at 990, the interactive media display system may receive user input via a motion sensor or user identification reader that may be operatively coupled with processing subsystem 920. As another example, a user input device 992 may reside external the interactive media display system, and may include one or more of a keyboard, a mouse, a joystick, camera, or other suitable user input device. User input device 992 may be operatively coupled to processing subsystem 920 by wired or wireless communication. In this way, the interactive media display surface can receive user input by various user input devices.

It should be understood that the indication-determining capabilities described herein may be applied to virtually any computing system, including the above described surface computing system, but also including personal computers, tablet computers, personal data assistants, mobile phones, mobile media players, and others.

The embodiments described herein may be implemented, for example, via computer-executable instructions or code, such as programs, stored on computer-readable storage media and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer,” “computing device,” “computing system,” and the like include any device that electronically executes one or more programs, including two or more such devices acting in concert.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of activating a graphical user interface element, comprising:
presenting the graphical user interface element via a touch-sensitive display surface;
receiving a user input at the touch-sensitive display surface;
determining whether one or more secondary factors associated with the user input indicate an intentional contact with the graphical user interface element that is presented via the touch sensitive display surface;
activating the graphical user interface element if the one or more secondary factors indicate the intentional contact with the graphical user interface element; and
disregarding the user input by not activating the graphical user interface if the one or more secondary factors do not indicate the intentional contact.

2. The method of claim 1, where receiving the user input at the touch-sensitive display surface includes recognizing an object contacting the touch-sensitive display surface.

3. The method of claim 2, where the one or more secondary factors include a contact duration of the user input at the touch-sensitive display surface.

4. The method of claim 2, where the one or more secondary factors include a characteristic of the object through which the user input contacts the touch-sensitive display surface.

5. The method of claim 4, where the characteristic includes a shape of the object.

6. The method of claim 2, where the one or more secondary factors include a contact distance travelled by the object across the touch-sensitive display surface.

7. The method of claim 2, where the one or more secondary factors include a contact velocity travelled by the object across the touch-sensitive display surface.

8. The method of claim 2, where the one or more secondary factors include a contact movement direction travelled by the user input across the touch-sensitive display surface.

9. The method of claim 2, where the one or more secondary factors include a contact orientation at which the object contacts the touch-sensitive display surface.

10. The method of claim 1, where determining whether one or more secondary factors indicate the intentional contact includes comparing the one or more of the secondary factors to an activation criterion; and
where the method further comprises selecting the activation criterion in accordance with a size of the graphical user interface element that is presented via the touch-sensitive display surface.

11. An interactive media display system, comprising:
a touch-sensitive display surface configured to present a graphical user interface element;
a logic subsystem; and
memory holding executable instructions that, when executed by the logic subsystem, cause the logic subsystem to:
identify an initial location where the touch-sensitive display surface is initially contacted by an object;
identify a final location where the object discontinues contact with the touch-sensitive display surface; and
activate the graphical user interface element only if:
a contact distance between the initial location and the final location exhibits a pre-determined relationship to a threshold contact distance;
a contact duration between a time when the object initially contacts the touch-sensitive display surface at the initial location and a time when the object discontinues contact at the final location exhibits a pre-determined relationship to a threshold contact duration; and
a contact velocity of the object between the initial location and the final location exhibits a predetermined relationship to a threshold contact velocity.

12. The interactive media display system of claim 11, where the executable instructions further cause the logic subsystem to:
adjust one or more of the threshold contact distance, the threshold contact duration, and the threshold contact velocity based on a size of the graphical user interface element that is presented via the touch-sensitive display surface.

13. The interactive media display system of claim 11, where the executable instructions further cause the logic subsystem to:
select a magnitude of at least one of the threshold contact distance, the threshold contact duration, and the threshold contact velocity based on a magnitude of another of the threshold contact distance, the threshold contact duration, and the threshold contact velocity.

14. The interactive media display system of claim 11, where the executable instructions further cause the logic subsystem to:
activate the graphical user interface element only if the initial location is at a location where the graphical user interface element is presented via the touch-sensitive display surface or if the final location is at the location where the graphical user interface element is presented via the touch-sensitive display surface.

15. The interactive media display system of claim 11, where the executable instructions further cause the logic subsystem to:
identify a proximity of the object to the graphical user interface element that is presented via the touch-sensitive display surface; and
activate the graphical user interface element only if the proximity of the object to the graphical user interface element exhibits a pre-determined relationship to a threshold proximity.

16. A method of activating a graphical user interface element, comprising:
presenting a graphical user interface element via the touch-sensitive display surface;
recognizing a user input contacting the touch-sensitive display surface;
selecting an activation criterion for the graphical user interface element in accordance with a size of the graphical user interface element that is presented via the touch-sensitive display surface;
activating the graphical user interface element if the activation criterion is satisfied by one or more secondary factors associated with the user input; and
disregarding the user input by not activating the graphical user interface if the activation criterion is not satisfied by the one or more secondary factors associated with the user input.

17. The method of claim 16, where the one or more secondary factors includes a contact duration of the user input contacting the touch-sensitive display surface.

18. The method of claim 17, where the one or more secondary factors further includes a contact distance of the user input along the touch-sensitive display surface.

19. The method of claim 18, where the one or more secondary factors further includes a contact velocity of the user input along the touch-sensitive display surface.

20. The method of claim 16, where the activation criterion includes a threshold value to be exhibited by the one or more of the secondary factors for the activation criterion to be satisfied.
